(19) United States
(12) Patent Application Publication
(10) Pub. No.: US 2004/0181503 A1
(43) Pub. Date: Sep. 16, 2004

(54) Information storage and retrieval method and apparatus

(75) Inventors: Kathy Moseler, Barrington, IL (US); Zhongli He, Schaumburg, IL (US); Chandrasekhar Lakshmanan, Schaumburg, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/387,687

(22) Filed: Mar. 13, 2003

(51) Int. Cl. G06F 7/00

(52) U.S. Cl. 707/1

(57) ABSTRACT

Multi-dimensional information is stored as a plurality of predetermined shares of data, wherein at least some of the predetermined shares of data each comprises a plurality of data elements with each one of the plurality of data elements being associated with a different distinct memory bank. Data parsed and arrayed in this way can then be selectively recalled to readily and easily accommodate a variety of data processing needs without an attendant need for complex addressing schemes and the like.

### RELATED APPLICATIONS

Programmable Video Encoding Accelerator Method and Apparatus (attorney's docket number CML01083N/78585) as filed on even date herewith, and Programmable Video Motion Accelerator Method and Apparatus (attorney's docket number CML01082N/78584) as also filed on even date herewith, wherein both such related applications are incorporated herein by this reference.

### TECHNICAL FIELD

This invention relates generally to information storage and retrieval and more particularly to the formatting of stored multi-dimensional information.

### BACKGROUND

Storage of information represented in digital form comprises a well-understood area of prior art endeavor. Numerous centralized and distributed storage techniques and configurations are used and/or have been proposed to serve a wide variety of purposes. Unfortunately, there are at least some processing applications for which present storage and memory-accessing techniques are not fully satisfactory.

For example, some applications (such as at least certain kinds of video data processing) are sufficiently computationally intensive so as to challenge the ability of such prior art approaches to provide adequate service without also necessitating complex memory control implementations. The latter requirement, in turn, can lead to power consumption needs that render such approaches unsuitable for at least some operations (such as applications in portable devices that rely upon a small, portable power supply).

As an even more specific example, video processing techniques that benefit (or rely) upon an ability to randomly access any pixel in multiple dimensions are often presently facilitated with memory organization techniques that, again, require complex control implementations. Such control mechanisms, in turn, tend to require an inordinate relative amount of physical space and available power. Further, such control mechanisms tend, due at least in part to their native complexity, to support and/or be useful only with a specific video processing approach or algorithm. This in turn tends to render such solutions relatively specific to only a given particular approach and consequently not particularly friendly to multi-platform solutions.

### BRIEF DESCRIPTION OF THE DRAWINGS

The above needs are at least partially met through provision of the information storage and retrieval method and apparatus described in the following detailed description, particularly when studied in conjunction with the drawings, wherein:

FIG. 1 comprises a block diagram of a visual processor as configured in accordance with an embodiment of the invention;

FIG. 2 comprises a schematic diagram of multi-dimensional information as organized in accordance with an embodiment of the invention;

FIG. 3 comprises a detail schematic diagram of multi-dimensional information as organized in accordance with another embodiment of the invention;

FIG. 4 comprises a detail schematic diagram of multi-dimensional information as distributed with respect to a plurality of memory banks in accordance with an embodiment of the invention;

FIG. 5 comprises a detail schematic representation of four memory banks as configured in accordance with an embodiment of the invention;

FIG. 6 comprises a schematic representation of a half-pixel access pattern as configured in accordance with an embodiment of the invention; and

FIG. 7 comprises a detail block diagram as configured in accordance with yet another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, multi-dimensional information is stored such that the store of data comprises a plurality of predetermined shares of data, wherein at least some of the predetermined shares of data each comprises a plurality of data elements with each one of the plurality of data elements being associated with a different distinct memory bank. A programmable data transfer process can then be used to facilitate selection of a particular way to transfer this store of data to a data processing platform.

In one embodiment, the data processing platform comprises a programmable arithmetic processing unit (such as may comprise a part of a visual information processor).

In a preferred embodiment and particularly when employed with X-Y-configured multi-dimensional information, the predetermined shares each include four data elements.

The various ways of transferring the store of data to a data processing platform can include, but are not limited to, selection of an information row-based way of transferring the data, an information column-based way of transferring the data, and an information multidimensional predetermined share-based way of transferring the data (where, for example, the share-based way can comprise a 2×2 data element array).

So configured, information can be readily recalled for use with a relatively non-complex control and/or addressing protocol and process. Video information processing in particular can benefit from use of such approaches.

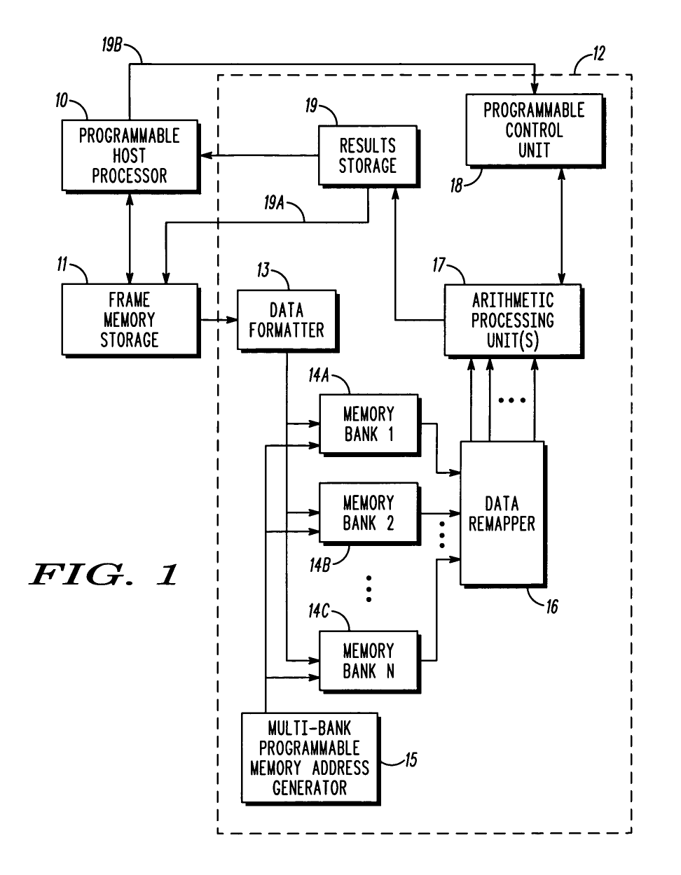

Referring now to the drawings, and in particular to FIG. 1, these information storage and retrieval concepts will be presented, for purposes of illustration, within the context of a video data processor. It should be understood, however, that such a context serves an illustrative purpose only, and that these concepts are readily applicable elsewhere as well.

In this embodiment, the video processor includes a programmable host processor 10 as is generally well understood in the art and a frame memory storage 11 that operably couples thereto. So configured, multi-dimensional information such as, for example, a frame of video data, can be stored pursuant to whatever memory scheme is desired and or appropriate to the application. The frame memory storage 11 can comprise any of a wide variety of memory mechanisms, including but not limited to memory caches (including but not limited to least-recently-used caches, though when using such a device it may be appropriate to store a sub-frame as versus a complete video frame depending upon the size of the frame and the size of the cache) as may be suitable and appropriate for use in a given application. This frame memory storage 11 is then operably coupled to a video processing accelerator 12.

In this embodiment, the video processing accelerator 12 includes generally an arithmetic processing unit (or units) 17 that process the multi-dimensional information in accordance with one or more video processing techniques (such as, for example, motion estimation and/or motion compensation processing techniques as are well known in the art) as preferably controlled by a programmable control unit 18. It is also possible that the programmable control unit 18 is further programmed by the host either by downloading control code or by setting preset parameters via a control line 19B. Control code executing on the host processor 10 could also provide control when preset parameters are used. A combination of these two techniques is also possible. A results storage 19 then receives and buffers the processed video data and/or returns the processed video data to the programmable host processor 10. The results storage 19 could also bypass the host processor 10 and return the processed video data directly to the frame memory 11 via a data line 19A provided for that purpose. The above components and modules are generally well understood in the art, both individually and in combination as suggested, and hence additional description will not be provided here for the sake of brevity and the preservation of focus.

In this embodiment, the multi-dimensional information is preferably formatted and stored so as to facilitate an efficacious transfer of such data to the arithmetic processing unit 17. In particular, the multi-dimension information as obtained from the frame memory storage 11 is redistributed by a data formatter 13 over a plurality of memory banks 14A-C. There can be as many memory banks as desired and/or as appropriate to the needs of a given application or, for example, the geometry of the formatting process itself (as explained below in more detail). The memory banks themselves can be physically or logically discrete, in whole or in part, from one another as desired and/or as appropriate to a given application. Any suitable memory architecture can be utilized including, but not limited to, a least-recently-used memory cache. Therefore, and to illustrate with a simple example, a single physical cache memory can be used to comprise a plurality of memory banks, or a separate cache memory can be used for each of the memory banks.

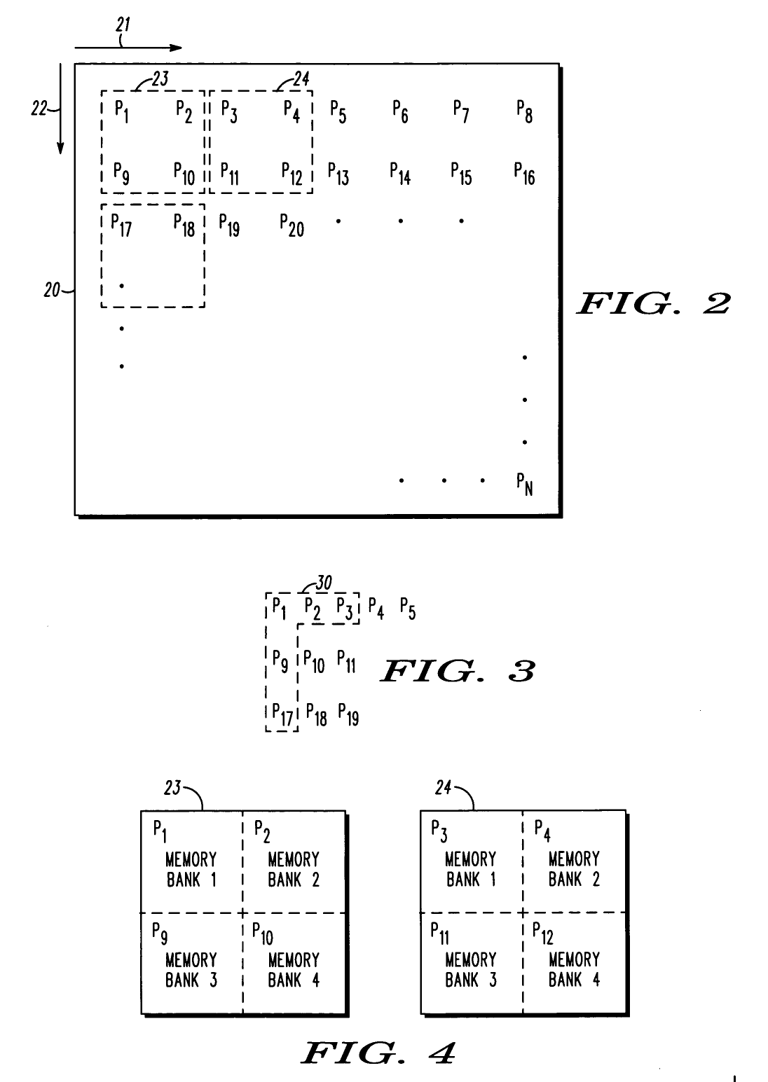

With momentary reference to FIG. 2, for purposes of this example, the multi-dimensional information 20 comprises video pixel information wherein each pixel has a unique X-Y location on a corresponding display in accordance with well understood prior art practice. Such information can be viewed as comprising two-dimensional information, with the two dimensions 21 and 22 effectively representing the row and column positions of the pixels. (Information corresponding to dimensions of other degrees is of course possible, as where multi-dimensional data arrays are used to represent phenomena of various kinds, and all such configurations are to be considered as within the ambit of these embodiments.) Therefore, and still for purposes of this example, a first pixel P₁ can be seen to occupy a position in a first row and a first column. A second pixel P₂ can similarly be seen to occupy a position in the first row but in a second column, and so forth until all pixels up to a last pixel P_{N} are accounted for.

Pursuant to a preferred embodiment, the data formatter 13 parses and assigns such data elements (i.e., individual pixels in this illustration) to a plurality of predetermined shares of data. For example, pixels P₁, P₂, P₉, and P₁₀ are all assigned to one predetermined share of data 23 while pixels P₃, P₄, P₁₁, and P₁₂ are all assigned to another predetermined share of data 24. For purposes of this illustrative example, each predetermined share of data comprises a 2×2 block array of pixel data elements. Such an array shape in fact serves well for many purposes. If desired, however, other shapes or sharing schemes can be utilized as well. (To quickly illustrate this point with but one of many possible examples, and with brief momentary reference to FIG. 3, for example, 5 pixels (P₁, P₂, P₃, P₉, and P₁₇) can be grouped in a right-angle formation 30 as illustrated.) Then, within each such predetermined share of data, the constituent data elements are individually assigned to different distinct memory banks 14A-C.

To illustrate, reference is made to both FIGS. 2 and 4, where it can be seen that a first predetermined share of data 23 comprised of the four pixels P₁, P₂, P₉, and P₁₀ has those constituent data elements parsed and assigned over four memory banks such that pixel P₁ is assigned to memory bank 1, pixel P₂ is assigned to memory bank 2, pixel P₉ is assigned to memory bank 3, and pixel P₁₀ is assigned to memory bank 4 (in this example it is presumed that there are a total of four different and discrete memory banks). In a similar fashion, the data elements occupying similar locations in a second predetermined share of data 24 are parsed and assigned to similar corresponding memory bank locations, such that pixel P₃ is assigned to memory bank 1, pixel P₄ is assigned to memory bank 2, pixel P₁₁ is assigned to memory bank 3, and pixel P₁₂ is assigned to memory bank 4.

In this way, all of the data elements that comprise the multi-dimensional information are ultimately assigned, on a share by share basis, to one of the available memory banks. If desired, of course, for purposes of redundancy or as may otherwise be preferred, one or more of the data elements may be stored in parallel in more than one of the memory banks. It would also be possible to use differently configured shares for some data elements on some dynamically-assigned basis (for example, a 2×2 pixel block as illustrated could be used for some pixels and a 3×3 pixel block (not shown) could be used for other pixels as dictated by whatever selection scheme might be appropriate to the application in question).

To illustrate these concepts in a somewhat different way, when the spatial arrangement of the pixels that comprise a given frame of video information is presented as follows:

A₁₁ B₁₁ A₁₂ B₁₂ - - - A₁ⱼ B₁ⱼ
C₁₁ D₁₁ - - - C₁ⱼ D₁ⱼ
A₂₁ B₂₁ - - - A₂ⱼ B₂ⱼ
C₂₁ D₂₁ - - - C₂ⱼ D₂ⱼ
.
.
.
Aᵢ₁ Bᵢ₁ Aᵢ₂ Bᵢ₂ - - - Aᵢⱼ Bᵢⱼ
Cᵢ₁ Dᵢ₁ Cᵢ₂ Dᵢ₂ - - - Cᵢⱼ Dᵢⱼ

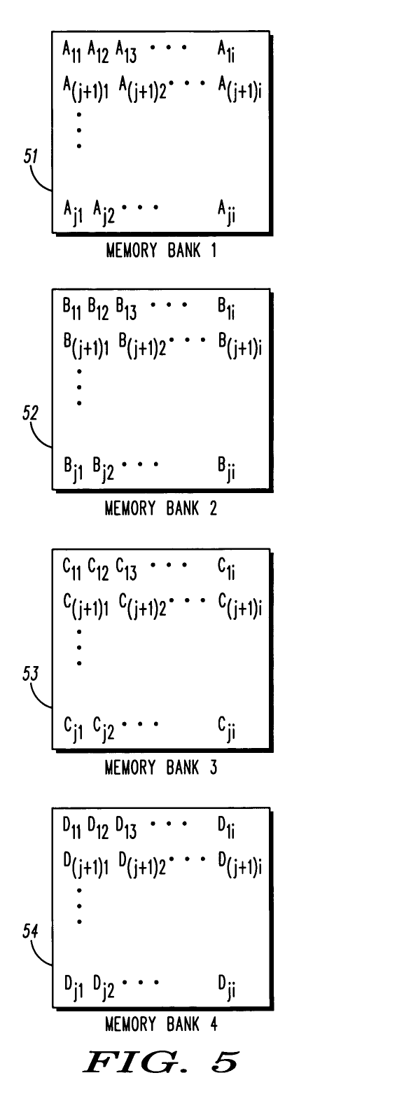

then the pixels denoted by Aᵢⱼ, Bᵢⱼ, Cᵢⱼ, and Dᵢⱼ are stored in the four different memory banks as illustrated in FIG. 5. In particular, pixels A₁₁ through Aⱼᵢ are all stored in memory bank 1 51, pixels B₁₁ through Bⱼᵢ are all stored in memory bank 2 52, pixels C₁₁ through Cⱼᵢ are all stored in memory bank 3 53, and pixels D11 through Dji are all stored in memory bank 4 54.

In this particular embodiment, the pixels comprising the multi-dimensional information are stored in a two-dimensional interleaved fashion. Such an arrangement facilitates relatively easy access to the four adjacent locations that comprise the four quadrants of each predetermined share. By providing data that is arrayed over multiple dimensions rather than the more common single-dimension data arrangement, simpler and more efficient arithmetic processing circuits can be utilized, thereby lowering cost and also reducing a total number of processing cycles that are required to perform multiple algorithms.

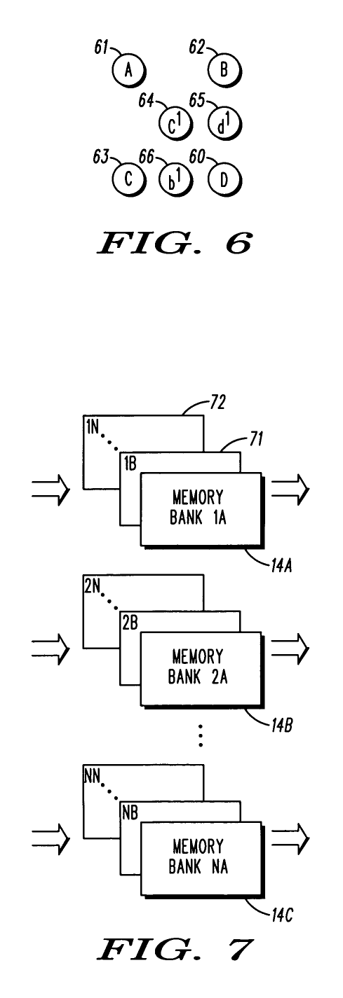

One exemplary video processing algorithm that can benefit from such an approach is half-pixel refinement of an integer motion estimation search. In particular, the spatial arrangement of pixels over the four memory banks permits pixel access in a fashion that facilitates an easier method of calculating interpolated pixels for half-pixel refinement. To illustrate, FIG. 6 depicts an access pattern utilized, in this embodiment, to facilitate half-pixel refinement. In this illustration, the “D” pixel 60 comprises a current pixel position and the remaining pixels A 61, B 62, and C 63 are other pixels that share the same predetermined share of data with the D pixel 60 and that are therefore also readily available for immediate production when recalling the current pixel position D 60. These immediately and inherently recalled data elements are then immediately usable to calculate half-pixel interpolated positions of interest as otherwise understood in the art. For example, it can be seen that the half-pixel interpolated positions represented by b′ 66, c′ 64, and d′ 65 can each be represented and determined by:

b′=(C+D+1-rounding_control)/2

c′=(A+B+C+D+2-rounding_control)/4

d′=(B+D+1-rounding_control)/2.

As already emphasized earlier, notwithstanding the significant benefits of recalling the data elements in this fashion, this access pattern requires no special controls.

As another example, the described approach can be readily adapted to perform sub-sampled motion estimation (that is, sub-sampling by skipping every alternate pixel in an x and/or y direction). To effect this, one could use only one or two of the memory banks and still maintain linear access. In effect, one could achieve the effect of selecting only row-based data elements by recalling only, for example, horizontally adjacent memory banks, or the effect of selecting only column-based data elements by recalling only vertically adjacent memory banks. Such may be desirable, for example, when facilitating a particular algorithm that is designed to process data appearing in such a form. Other multi-dimensional shapes or arrays are also potentially available, depending to some extent only upon the number of memory banks and the parsing and assignment pattern(s) used when writing the data elements to the memory banks.

An additional example for the case where the data is not interleaved is a situation where the video frame is divided into multiple rectangular sections that may or may not be overlapping and may or may not consist of arbitrarily shaped video objects. The individual sections could then be stored in separate memory banks that would enable them to be processed independently and in parallel. The ability to process the sections independently would again have the advantage of simplifying the control circuitry needed for accessing the data while parallel processing has the advantage of speeding-up the processing. This illustration demonstrates the utility of these embodiments when implementing, for example, various MPEG-4 profiles.

Returning again to FIG. 1, the memory banks 14A-C can be manipulated and controlled as described by a multi-bank programmable memory address generator 15. In a preferred embodiment, the multi-bank programmable memory address generator 15 can provide different addresses to each memory bank in parallel. A data remapper 16 is then preferably used to effect a fully compatible transfer of the memory bank contents to the arithmetic processing unit(s) 17.

Those skilled in the art will recognize that a wide variety of modifications, alterations, and combinations can be made with respect to the above-described embodiments without departing from the spirit and scope of the invention, and that such modifications, alterations, and combinations are to be viewed as being within the ambit of the inventive concept. For example, with reference to FIG. 7, each memory bank 14A-C can itself comprise a part of a stack or deeper array of memory banks (to illustrate, memory bank 1A 14A can be part of a stack of memory banks that includes memory bank 1B 71 and that extends to memory bank 1N 72). Such depth can be used when appropriate to facilitate parallel processing and/or more rapid availability of data for presentation to the arithmetic processing unit(s) 17. The depth could also provide an indexing mechanism to enable the attachment of meaningful parameters that could later be used to quickly retrieve certain data groupings or to provide a means for sorting groups of predetermined shares that could, for example, represent video objects.

We claim:

1. A method comprising:
providing a data processing platform;
providing a store of data that corresponds to multi-dimensional information, wherein the store of data comprises a plurality of predetermined shares of data, wherein at least some of the predetermined shares of data each comprises a plurality of data elements with each one of the plurality of data elements being associated with a different distinct memory bank;
providing a programmable data transfer process to facilitate selection of a particular way to transfer data from the store of data to the data processing platform.

2. The method of claim 1 wherein the data processing platform comprises at least one programmable arithmetic processing unit.

3. The method of claim 2 wherein the at least one programmable arithmetic processing unit comprises a part of a visual information processor.

4. The method of claim 1 wherein providing a store of data that corresponds to multi-dimensional information, wherein the store of data comprises a plurality of predetermined shares of data includes providing a store of data that corresponds to multi-dimensional information, wherein the store of data comprises a plurality of predetermined shares of at least four data elements per predetermined share.

5. The method of claim 1 wherein providing a store of data that corresponds to multi-dimensional information, wherein the store of data comprises a plurality of predetermined shares of data includes providing a store of data that corresponds to multi-dimensional information, wherein the store of data comprises a plurality of predetermined shares of data elements wherein there is at least one data element per discrete information dimension for each such predetermined share of data elements.

6. The method of claim 1 wherein providing a programmable data transfer process to facilitate selection of a particular way to transfer data from the store of data to the data processing platform includes providing a programmable data transfer process to facilitate selection of an information row-based way to transfer data from the store of data to the data processing platform.

7. The method of claim 1 wherein providing a programmable data transfer process to facilitate selection of a particular way to transfer data from the store of data to the data processing platform includes providing a programmable data transfer process to facilitate selection of an information column-based way to transfer data from the store of data to the data processing platform.

8. The method of claim 1 wherein providing a programmable data transfer process to facilitate selection of a particular way to transfer data from the store of data to the data processing platform includes providing a programmable data transfer process to facilitate selection of an information multidimensional predetermined share-based way to transfer data from the store of data to the data processing platform.

9. The method of claim 1 and further comprising providing at least a second store of data that corresponds to second multi-dimensional information, wherein the at least a second store of data is structurally substantially identical to the store of data.

10. The method of claim 1 and further comprising:
providing the multi-dimensional information;
formatting the multi-dimensional information to properly fit within the store of data to provided formatted data;
formatting the multi-dimensional information as it is being read out of the store of data.

11. The method of claim 10 and further comprising moving the formatted data to and from the store of data.

12. The method of claim 1 wherein providing a programmable data transfer process to facilitate selection of a particular way to transfer data from the store of data to the data processing platform includes providing a programmable data transfer process wherein each of up to all of the available memory banks are available to transfer a corresponding data element per processing cycle.

13. The method of claim 12 wherein providing a programmable data transfer process wherein each of up to all of the available memory banks are available to transfer a corresponding data element includes providing a programmable data transfer process wherein less than all of the available memory banks are used to transfer a corresponding data element per processing cycle.

14. The method of claim 1 wherein providing a store of data includes providing at least a portion of the store of data in a memory cache.

15. An apparatus comprising:
a programmable data processing unit having a plurality of memory bank inputs;
a plurality of memory banks, wherein each one of the plurality of memory banks operably couples to a corresponding one of the plurality of memory bank inputs, and wherein each of the memory banks has stored therein at least one data element that corresponds to a multi-dimensional information source;
a memory address generator operably coupled to each of the plurality of memory banks such that data elements as stored in selected ones of the plurality of memory banks can be transferred, substantially in parallel, to the programmable data processing unit.

16. The apparatus of claim 15 wherein the programmable data processing unit comprises an arithmetic data processing unit.

17. The apparatus of claim 16 wherein the arithmetic data processing unit comprises a part of a visual information processing unit.

18. The apparatus of claim 15 wherein the data elements that correspond to the multi-dimensional information source are grouped as predetermined shares.

19. The apparatus of claim 18 wherein the multi-dimensional information source has N dimensions and wherein the predetermined shares have at least N dimensions.

20. The apparatus of claim 15 wherein the multi-dimensional information source has N dimensions and wherein there are at least N² memory banks.

21. The apparatus of claim 15 wherein the memory address generator includes address selection means for addressing the memory banks to facilitate a transfer of horizontally aligned data elements to the programmable data processing unit.

22. The apparatus of claim 15 wherein the memory address generator includes address selection means for addressing the memory banks to facilitate a transfer of vertically aligned data elements to the programmable data processing unit.

23. The apparatus of claim 15 wherein the memory address generator includes address selection means for individually addressing the memory banks to facilitate a transfer of predetermined share-arrayed data elements to the programmable data processing unit.

24. The apparatus of claim 15 wherein the memory address generator includes address selection means for selectively addressing the memory banks to selectively facilitate a correspond transfer of any of:
horizontally aligned data elements to the programmable data processing unit;
vertically aligned data elements to the programmable data processing unit;
predetermined share-arrayed data elements to the programmable data processing unit.
selectively arrayed data elements to the data processing unit.

25. The apparatus of claim 15 wherein the memory address generator comprises a programmable memory address generator.

26. The apparatus of claim 15 and further comprising at least one memory cache and wherein at least a portion of some of the plurality of memory caches are built with a plurality of memory banks.
